(19) United States
(12) Patent Application Publication
(10) Pub. No.: US 2026/0277685 A1
(43) Pub. Date: Sep. 17, 2026

(54) METHOD FOR CHECKING THE EQUALITY OF MULTIPLE INTERMEDIATE RESULTS

(71) Applicant: Robert Bosch GmbH, Stuttgart (DE)

(72) Inventors: Sascha Guebner, Bodenburg (DE); Peter Schneider, Holzgerlingen (DE); Vera Schumacher, Gerlingen (DE)

(21) Appl. No.: 19/386,736

(22) Filed: Nov. 12, 2025

(30) Foreign Application Priority Data
Nov. 19, 2024 (DE) 10 2024 211 097.3

(51) Int. Cl. G06F 9/50

(52) U.S. Cl. CPC G06F 9/5027

(57) ABSTRACT

A method for checking the equality of multiple intermediate results from multiple redundant calculations using multiple identical application software instances. The processing of the same input data is monitored by a program flow control. This program flow control is used to check the equality of the intermediate results. In this process, an intermediate key in the program flow control can be modified such that the program flow signature is correct only if the intermediate results to be checked are equal. A system for checking the equality of multiple intermediate results from multiple redundant calculations, a computer program, and a machine-readable storage medium, are also described.

### CROSS REFERENCE

The present application claims the benefit under 35 U.S.C. § 119 of Germany Patent Application No. DE 10 2024 211 097.3 filed on Nov. 19, 2024, which is expressly incorporated herein by reference in its entirety.

### FIELD

The present invention relates to a method and a system for checking the equality of multiple intermediate results from multiple redundant calculations, to a computer program and a machine-readable storage medium.

### BACKGROUND INFORMATION

Germany Patent Application No. DE 10 2007 040 721 A1 describes a data processing arrangement.

Germany Patent Application No. DE 10 2010 037 457 A1 describes a data processing method for providing a value for ascertaining whether an error has occurred during the execution of a program.

Germany Patent Application No. DE 10 2014 117 971 A1 describes a data processing method for ascertaining whether an error has occurred during the execution of a program.

U.S. Pat. No. 9,304,872 B2 describes a method for providing a value in order to determine whether an error has occurred during the execution of a program.

In real-time critical systems, redundant instances are usually executed in a so-called (hardware or software) lockstep mode in order to ensure the safety integrity of a calculation on more complex hardware. In this process, each calculation result of the (usually 2) redundant instances is first compared in a so-called comparator and is only output for further processing (e.g., control of an actuator) if the comparison was successful.

One difficulty, for example, is that the comparator itself must be intrinsically safe and, in particular, the error “comparator always reports ‘comparison successful’ even with differing input data” must be avoided. The comparator can either be implemented directly in hardware using particularly robust/reliable comparator circuits or be outsourced to a special “safe island” (e.g., a safety ASIC).

Cross-comparisons of the results between two instances are also common in some well-known methods; however, a reliable and fast error response of both instances (e.g., in the case that a cross-comparison fails in only one of the two instances, i.e., the states of the two comparators differ) is usually only possible via a further independent monitor.

### SUMMARY

An object of the present invention is to provide a way to check the equality of multiple intermediate results from multiple redundant calculations.

This object is achieved by means of the certain features of the present invention. Advantageous embodiments of the present invention are disclosed herein.

According to a first aspect of the present invention, a method for checking the equality of multiple intermediate results from multiple redundant calculations is provided. According to an example embodiment of the present invention, the method comprises the following steps:

each of multiple identical application software instances receives the same input data,
each of the multiple application software instances receives the same value of a challenge key,
each of the multiple application software instances processes the input data,
wherein, during the processing of the input data by each of the multiple application software instances, multiple checkpoints of a program flow control carried out using the value of the challenge key are passed through,
wherein each of the application software instances calculates and hashes a particular intermediate result of the input data processing between each pair of identical checkpoints of the multiple checkpoints of the program flow controls within the framework of the input data processing in order to calculate a particular hash value of the calculated intermediate result, wherein the application software instances exchange the hash value calculated by the particular application software instance itself,
wherein each of the application software instances uses the hash value calculated by the particular application software instance itself and the particular hash value of the other application software instance(s) according to a common calculation rule for the remaining program flow control in order to generate a value of a response key at the particular end of the particular program flow control,
the generated values of the response key are compared in order to check the equality of the intermediate results.

According to a second aspect of the present invention, a system for checking the equality of multiple intermediate results from multiple redundant calculations is provided. According to an example embodiment of the present invention, the system comprises:

multiple identical application software instances,
wherein the system is configured to perform all steps of the method according to the first aspect.

According to a third aspect of the present invention, a computer program is provided, comprising commands that, when the computer program is executed by the system according to the second aspect, cause the system to perform a method according to the first aspect of the present invention.

According to a fourth aspect of the present invention, a machine-readable storage medium is provided, on which the computer program according to the third aspect of the present invention is stored.

The present invention is based on and includes the finding that the above object is achieved by using a program flow control for checking the equality of intermediate results. In particular, it is provided to modify an intermediate key in the program flow control such that the program flow signature is correct only if the values to be checked are equal. The execution of this indirect comparison is advantageously ensured by the program flow control itself and also takes place on all redundant instances. Furthermore, potential error propagation from one redundant instance to another by transmitting incorrect payload data can be avoided since only hashes of the data are compared rather than raw data. This also advantageously reduces communication and storage costs and advantageously allows for efficient storage of the hashes in order to detect so-called STUCK-AT errors or periodically occurring errors more reliably.

In other words, according to the present invention described here, it is provided that, for checking the equality of multiple intermediate results, each application software instance hashes the intermediate results in order to calculate a particular hash value of the self-calculated intermediate result. The application software instances exchange their respective self-calculated hash values with one another. The corresponding hash values received are then used by each application software instance to carry out the remaining program flow control. At the end of the program flow control, each application software instance generates a value of a response key.

If all intermediate results are equal, all hashes are also equal and, if the program flow control is executed correctly, the same value of the response key should therefore be generated at the end in each case. By comparing these generated values of the response key, it can advantageously be ascertained whether the intermediate results are equal or unequal.

If the values of the response key are equal, it can be specified, for example, that the intermediate results are equal. Otherwise, it can be specified, for example, that the intermediate results are unequal and/or that, for example, an error has occurred in the program flow control or in the processing.

The equality of multiple intermediate results can thus be checked efficiently.

The present invention described here thus advantageously allows for a more fine-grained comparison of (intermediate) results and not just a checksum-based comparison of the final results.

For example, this can advantageously provide a way to respond early to errors, i.e., unequal intermediate results, in further signal processing, for example to stop functions, to execute an auto-restart, or to resynchronize relevant states.

Exchanging hash values is safe because no (potentially dangerous) real signals are exchanged, only hash values (which are harmless because they are unusable in the potential signal receiver).

It is noted at this point that the terms “hash” and “hash value” can be used synonymously.

Depending on the size of the hash value, a hash collision (identical hashes even though the data are different) can advantageously be virtually ruled out. This allows a suitable hash function to be selected depending on the requirements.

In one example embodiment of the method of the present invention, it is provided that a target value of the response key is calculated by a monitoring device implemented independently of the multiple application software instances, based on the value of the challenge key and assuming that all application software instances have calculated identical intermediate results and that all respective checkpoints of the program flow controls have been passed through in a correct order, wherein the monitoring device compares the target value of the response key with the generated values of the response key in order to check the equality of the intermediate results.

This results, for example, in the technical advantage that the comparison can be carried out efficiently so that the equality of the intermediate results can be checked efficiently.

The independently implemented monitoring device is implemented, for example, as hardware and/or as software. For example, the monitoring device is implemented on a data processing device that is independent of the multiple application software instances.

In one example embodiment of the method of the present invention, it is provided that the common calculation rule specifies that one or more mathematical operators link a value of an intermediate response key of the particular program flow control, which value was calculated at one of the two identical checkpoints which, with respect to an order of the checkpoints with regard to the program flow control, lies before the other of the two identical checkpoints, with the respective hash values, wherein each application software instance uses a particular result of the linkage as a new value of the intermediate response key for the program flow control to be carried out at the other of the two identical checkpoints.

This results, for example, in a technical advantage that changing the intermediate response key itself is also part of the program flow control and is not skipped unnoticed, for example due to a hardware error.

In one example embodiment of the method of the present invention, it is provided that the common calculation rule specifies that each application software instance uses the respective hash values at one or more checkpoints following one of the two identical checkpoints, to calculate a value of a further intermediate response key of the particular program flow control.

This results, for example, in the technical advantage that changing the intermediate response key itself is also part of the program flow control and is not skipped unnoticed, for example due to a hardware error.

In one example embodiment of the method of the present invention, it is provided that, in the case of two application software instances, the common calculation rule specifies that one of the hash values is added to the value of the intermediate response key and that the other hash value is subtracted from the value of the intermediate response key.

This results, for example, in the technical advantage that a calculation rule that can be carried out particularly easily is specified.

In one example embodiment of the method of the present invention, it is provided that, in the case of two application software instances, the common calculation rule specifies that the value of the intermediate response key and the two hash values are in each case linked with an XOR operator.

This results, for example, in the technical advantage that a calculation rule that can be carried out particularly easily is specified.

In one example embodiment of the method of the present invention, it is provided that, in the case of two application software instances, the common calculation rule specifies that the value of the intermediate response key is multiplied by one of the hash values, divided by the other hash value, and added to the result of linking both hash values using the modulo operator.

This results, for example, in a technical advantage that an operation different from addition and the XOR operator can be used to allow for a certain degree of diversification.

In one example embodiment of the method of the present invention, it is provided that the input data comprise environmental data describing an environment of a motor vehicle, wherein the intermediate result is an element from the following group of intermediate results: object list of objects in the environment of the motor vehicle, open spaces in the environment of the motor vehicle, object classification.

This results, for example, in the technical advantage that particularly suitable input data and particularly suitable intermediate results can be provided.

The method is, for example, carried out by means of the system.

The system is, for example, programmatically configured to execute the computer program.

The method is, for example, a computer-implemented method.

Multiple identical application software instances comprise, for example, two identical application software instances, three identical application software instances, or four or more identical application software instances.

Method features result analogously from corresponding system features, and vice versa.

For example, exactly two identical application software instances are provided. For example, exactly three identical application software instances are provided. For example, exactly four identical application software instances are provided. For example, exactly five identical application software instances are provided.

For example, it is provided that each application software instance is executed on its own computer. For example, a computer executes multiple application software instances. A computer, as described, can also be a virtual computer or, for example, a physical computer.

The embodiments and exemplary embodiments of the present invention described here can be combined with one another in any way even if this is not explicitly described.

The system of the present invention comprises, for example, the monitoring device.

The present invention is explained in more detail below using preferred exemplary embodiments.

### BRIEF DESCRIPTION OF THE DRAWINGS

FIG. 1 shows a flowchart of a method according to the first aspect of the present invention.

FIG. 2 shows a system according to the second aspect of the present invention.

FIG. 3 shows a machine-readable storage medium according to the fourth aspect of the present invention.

FIG. 4 shows a block diagram according to an example embodiment of the present invention.

### DETAILED DESCRIPTION OF EXAMPLE EMBODIMENTS

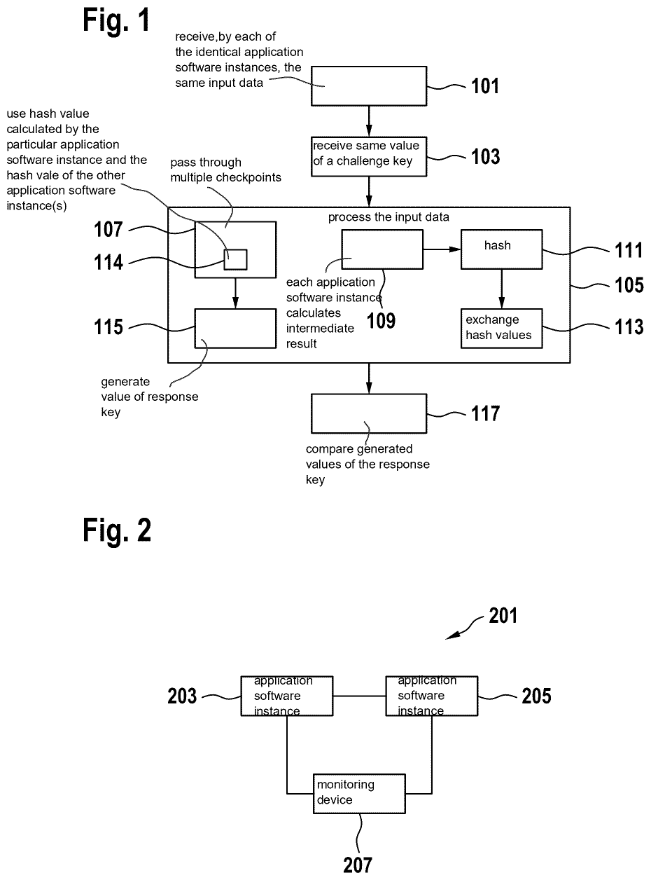

FIG. 1 shows a flowchart of a method for checking the equality of multiple intermediate results from multiple redundant calculations, comprising the following steps:

each of multiple identical application software instances receives 101 the same input data,
each of the multiple application software instances receives 103 the same value of a challenge key,
each of the multiple application software instances processes 105 the input data,
wherein, during the processing of the input data by each of the multiple application software instances, multiple checkpoints of a program flow control carried out using the value of the challenge key are passed through 107,
wherein each of the application software instances calculates 109 and hashes 111 a particular intermediate result of the input data processing between each pair of identical checkpoints of the multiple checkpoints of the program flow controls within the framework of the input data processing in order to calculate a particular hash value of the calculated intermediate result,
wherein the application software instances exchange 113 the hash value calculated by the particular application software instance itself,
wherein each of the application software instances uses 114 the hash value calculated by the particular application software instance itself and the particular hash value of the other application software instance(s) according to a common calculation rule for the remaining program flow control in order to generate a value 115 of a response key at the particular end of the particular program flow control,
the generated values of the response key are compared 117 in order to check the equality of the intermediate results.

FIG. 2 shows a system 201 for checking the equality of multiple intermediate results from multiple redundant calculations, comprising:

multiple identical application software instances 203, 205, wherein the system is configured to perform all steps of the method according to the first aspect.

The system 201 comprises a monitoring device 207, which is implemented independently of the application software instances 203, 205. The monitoring device 207 is configured to calculate a target value of the response key based on the value of the challenge key and assuming that all application software instances 203, 205 have calculated identical intermediate results and that all respective checkpoints of the program flow controls have been passed through in a correct order, wherein the monitoring device 207 is configured to compare the target value of the response key with the generated values of the response key in order to check the equality of the intermediate results.

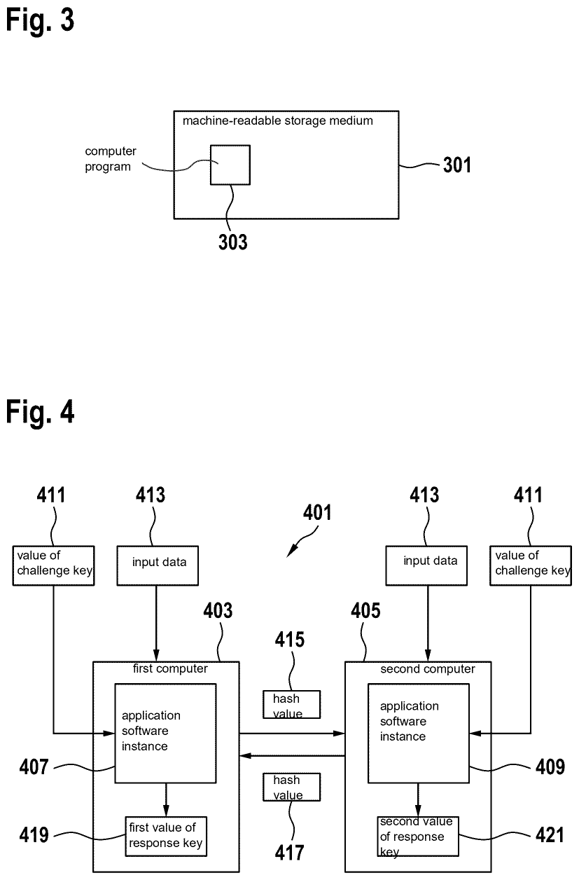

FIG. 3 shows a machine-readable storage medium 301, on which a computer program 303 is stored. The computer program 303 comprises commands that, when the computer program 303 is executed by the system according to the second aspect, cause the system to perform a method according to the first aspect.

FIG. 4 shows a block diagram 401, which by way of example illustrates the concept described here.

According to the block diagram 401, a first computer 403 and a second computer 405 are provided. The first computer 403 executes a first application software instance 407. The second computer 405 executes a second application software instance 409.

Both application software instances 407, 409 each receive the same value 411 of a challenge key. Both application software instances 407, 409 each receive the same input data 413.

The two computers 403, 405 each process the received input data 413 according to the concept described here, so that it is provided that the first computer 403 sends a first hash value 415 of a calculated intermediate result to the second computer 405. It is thus provided that the second computer 405 sends a second hash value 417 of a calculated intermediate result to the first computer 403. The two computers 403 and 405 thus exchange their respective self-calculated hash values 415, 417.

Accordingly, according to the concept described here, it is provided that the first computer 403 accordingly generates a first value 419 of a response key. Accordingly, it is provided that the second computer 405 generates a second value 421 of a response key. The two generated values 419, 421 are compared in order to check the equality of the intermediate results. For example, the comparison can be carried out by the monitoring device described in the description.

In the following explanations, “A” denotes the first computer 403. “B” denotes the second computer 405. “C” denotes a third computer, which is not shown in the figures, but which may be provided by way of example according to one embodiment.

When the term “computing unit” is used in the following explanations, “computer” is always implied, and vice versa. Both terms can be used synonymously.

“Data” below refers to the intermediate result. “h” denotes a hash function. “res” represents a value or intermediate value of the response key.

The program flow control described here thus monitors a program flow concerning the processing of the input data. The corresponding monitoring comprises, in particular, a transformation of the value of the challenge key to a value of a response key at respective checkpoints. These values of the response key at the checkpoints can also be referred to as intermediate values. Thus, for example, it is provided that, at each checkpoint of the program flow control, a correspondingly current intermediate value of the response key is transformed and, after all checkpoints have been correctly passed through, finally converted into the (final) value of the response key. For example, if a function executed by an application software instance wants to ensure that the calculated intermediate result, or the intermediate result of a calculation to be checked, (e.g., as part of function monitoring) is identical on all application software instances, one of the application instances exchanges the hash value of the result with the other application software instances. In the simplified example shown in FIG. 4, the application software instances are each executed redundantly on their own computer. These two application software instances therefore exchange their hash values, formed in particular by a hash function h, of the intermediate result. For example, it may be the case that a difference between these hash values is added to a current intermediate value of the program flow control. In particular, even after a modification of the intermediate value, a further checkpoint is provided in order to demonstrate advantageously that the calculation method, for example an addition of the hash difference, has in fact taken place.

“Addition” and “difference” can also be carried out efficiently by binary operations. For example, rather than:

calculation rule (1a ) res_{j,A}=res_{j,A}+h(data_{A})−h(data_{B})
the binary exclusive OR (XOR) can also be used:
calculation rule (1b) res_{j,A}=res_{j,A} XOR h(data_{A}) XOR h(data_{B})

As an alternative and/or in addition to “forming the difference,” multiplication can also be used:

calculation rule (2) res_{j,A}=res_{j,A}*(h(data_{A}) DIV h(data_{B}))+(h(data_{A}) MOD h(data_{B}));
here, “DIV” denotes the division with remainder and “MOD” denotes the modulo operation.

These calculations thus ensure that the intermediate key res_{j,A} remains unchanged only if the two hash values of the data from A and B are identical.

However, if the hash values differ from each other, the intermediate key is definitely changed and would ultimately lead to a different value of the response key. The latter would in turn lead to an error in the program flow signature, i.e., in the value of the response key, which can be detected by methods known per se.

For example, it is possible to check the equality of intermediate results from multiple application software instances. For example, it may be possible to extend the calculation (2) for the case of 3 application software instances (A, B, C) as follows:

calculation rule (5) res_{j,A}=res_{j,A} XOR ((h(data_{A}) XOR h(data_{B})) OR (h(data_{A}) XOR h(data_{C})) OR (h(data_{C}) XOR h(data_{B})))

In calculation rule (5), each pair of values (A, B), (A, C), and (B, C) is compared for equality by means of XOR and these results are combined by means of the binary OR operation. If a pair of values is unequal, the XOR combination yields a non-zero value that remains non-zero even after an OR operation. The result of the OR operation is then “added” to and/or multiplied by the intermediate key by means of XOR. And here too, the intermediate key remains unchanged only if all hash values of the computing units A, B, and C are identical.

The method can be extended analogously to 4 or more redundant application software instances, wherein simplifications in the calculation analogous to calculation rule (5) are in this case also possible.

An exemplary embodiment of the method is described below with reference to FIG. 4.

A function k is executed redundantly on computing units A and B, and their program flow is checked (program flow control). The computing units A and B may, for example, be separate computers but also virtual machines or containers on the same computer.

The following describes an exemplary step-by-step process as it can be implemented, in whole or in part, in an embodiment of the method according to the first aspect.

Step-by-step process
1) The same value of the challenge key c, which is required for the program flow control, is transmitted to the application software instances of the function k.
2) Input data are also transmitted to the application software instances. These input data may, for example, be sensor data or, in the case of a monitoring function, an intermediate result of a nominal function.
3) During the processing of the input data, the application software instances pass through at least one checkpoint of the program flow control and calculate the data/signals data to be compared. These data/signals may also be the same as the input data if no further calculation is necessary.
4) The application software instances form a hash of the data by means of a common hash function h. The hash function h only has to meet the usual requirements of a “good” hash function.
5) The functions exchange the calculated hash with one another via a suitable communication protocol.
6) The function instances perform a calculation of their own hash value and that of the other application software instances, e.g., by means of the calculation rules (1), (2), or (5) described above, with the current intermediate key of the program flow control.
7) Thereafter, the application software instances pass through at least one further checkpoint of the program flow control.
8) The thus generated final value of the response key of the function matches the expected key only if: (1) all checkpoints have been passed through exactly once in the correct sequence, and (2) the hash values of the exchanged data are identical.
9) The receiver of the value of the response key can thus be certain, upon receiving the value of the response key matching the value of the challenge key c, that all application software instances of the function have ascertained the same intermediate/final result.

Provided that this comparison of “received vs. expected value of the response key” is carried out on secure hardware, for example, the comparison of results can, for example, also be considered “secure.”

For example, the calculation rules (1a), (1b), (2) can be combined: e.g., forming the difference between a hash at checkpoint i and “multiplying” the same hash at checkpoint i+1. This reliably prevents individual faulty operations or individual permanently defective memory cells from leading to a masked (i.e., undetectable) error.

What is claimed is:

1. A method for checking equality of multiple intermediate results from multiple redundant calculations, comprising the following steps:
receiving, by each of multiple identical application software instances, the same input data;
receiving, by each of the multiple identical application software instances, the same value of a challenge key;
processing, by each of the multiple identical application software instances, the input data, wherein, during the processing of the input data by each of the multiple application software instances, multiple checkpoints of a program flow control carried out using the value of the challenge key are passed through;
calculating, by each of the multiple identical application software instances, a respective intermediate result of the input data processing between each pair of identical checkpoints of the multiple checkpoints of the program flow controls within a framework of the input data processing, and hashing, by each of the multiple identical application software instances, the calculated respective intermediate result to calculate a respective hash value of the calculated respective intermediate result;
exchanging by the multiple identical application software instances the respective hash values calculated by the multiple identical application software instances;
using, by each application software instance of the multiple identical application software instances, the respective hash value calculated by the application software instance and the respective hash value of the other application software instances or of the other application software instances according to a common calculation rule for remaining program flow control, to generate a respective value of a response key at a respective end of the program flow control; and
checking equality of the calculated respective intermediate results by comparing the generated respective values of the response key.

2. The method according to claim 1, wherein a target value of the response key is calculated by a monitoring device implemented independently of the multiple identical application software instances, based on the value of the challenge key and assuming that all of the multiple identical application software instances have calculated identical intermediate results and that all of the respective checkpoints of the program flow controls have been passed through in a correct order, wherein the monitoring device compares the target value of the response key with the generated respective values of the response key to check the equality of the calculated respective intermediate results.

3. The method according to claim 1, wherein the common calculation rule specifies that one or more mathematical operators link a value of an intermediate response key of the respective program flow control, which value was calculated at one of the two identical checkpoints which, with respect to an order of the checkpoints with regard to the program flow control, lies before the other of the two identical checkpoints, with the respective hash values, wherein each of the multiple identical application software instances uses a respective result of the linkage as a new value of the intermediate response key for the program flow control to be carried out at the other of the two identical checkpoints.

4. The method according to claim 3, wherein the common calculation rule specifies that each application software instance of the multiple identical application software instances uses the respective hash values at one or more checkpoints following one of the two identical checkpoints, to calculate a value of a further intermediate response key of the respective program flow control.

5. The method according to claim 3, wherein, when the multiple identical application software instances includes two application software instances, the common calculation rule specifies that one of the respective hash values is added to the value of the intermediate response key and that the other respective hash value is subtracted from the value of the intermediate response key.

6. The method according to claim 3, wherein, when the multiple identical application software instances includes two application software instances, the common calculation rule specifies that the value of the intermediate response key and the respective hash values are each linked with an XOR operator.

7. The method according to claim 3, wherein, when the multiple identical application software instances includes two application software instances, the common calculation rule specifies that the value of the intermediate response key is multiplied by one of the respective hash values, divided by the other of the respective hash values, and added to a result of linking the respective hash values using a modulo operator.

8. The method according to claim 1, wherein the input data include environmental data describing an environment of a motor vehicle, wherein the calculated respective intermediate results includes an element from the following group of intermediate results: object list of objects in the environment of the motor vehicle, open spaces in the environment of the motor vehicle, object classification.

9. A system for checking equality of multiple intermediate results from multiple redundant calculations, comprising:
multiple identical application software instances;
wherein the system is configured to perform the following steps including:
receiving, by each of multiple identical application software instances, the same input data,
receiving, by each of the multiple identical application software instances, the same value of a challenge key,
processing, by each of the multiple identical application software instances, the input data, wherein, during the processing of the input data by each of the multiple application software instances, multiple checkpoints of a program flow control carried out using the value of the challenge key are passed through,
calculating, by each of the multiple identical application software instances, a respective intermediate result of the input data processing between each pair of identical checkpoints of the multiple checkpoints of the program flow controls within a framework of the input data processing, and hashing, by each of the multiple identical application software instances, the calculated respective intermediate result to calculate a respective hash value of the calculated respective intermediate result,
exchanging by the multiple identical application software instances the respective hash values calculated by the multiple identical application software instances,
using, by each application software instance of the multiple identical application software instances, the respective hash value calculated by the application software instance and the respective hash value of the other application software instances or of the other application software instances according to a common calculation rule for remaining program flow control, to generate a respective value of a response key at a respective end of the program flow control, and
checking equality of the calculated respective intermediate results by comparing the generated respective values of the response key.

10. A non-transitory machine-readable storage medium on which is stored a computer program for checking equality of multiple intermediate results from multiple redundant calculations, the computer program, when executed by a system including multiple identical software instances, causing the system to perform the following steps comprising:
receiving, by each of the multiple identical application software instances, the same input data;
receiving, by each of the multiple identical application software instances, the same value of a challenge key;
processing, by each of the multiple identical application software instances, the input data, wherein, during the processing of the input data by each of the multiple application software instances, multiple checkpoints of a program flow control carried out using the value of the challenge key are passed through;
calculating, by each of the multiple identical application software instances, a respective intermediate result of the input data processing between each pair of identical checkpoints of the multiple checkpoints of the program flow controls within a framework of the input data processing, and hashing, by each of the multiple identical application software instances, the calculated respective intermediate result to calculate a respective hash value of the calculated respective intermediate result;
exchanging by the multiple identical application software instances the respective hash values calculated by the multiple identical application software instances;
using, by each application software instance of the multiple identical application software instances, the respective hash value calculated by the application software instance and the respective hash value of the other application software instances or of the other application software instances according to a common calculation rule for remaining program flow control, to generate a respective value of a response key at a respective end of the program flow control; and
checking equality of the calculated respective intermediate results by comparing the generated respective values of the response key.
